(19) United States
(12) Patent Application Publication
(10) Pub. No.: US 2004/0058147 A1
(43) Pub. Date: Mar. 25, 2004

(54) Antistatic film and process for its manufacture

(75) Inventors: Hideki Ozawa, Ichihara-shi (JP); Fumio Aoki, Ichihara-shi (JP)

Correspondence Address: IP DEPARTMENT OF PIPER RUDNICK LLP, 3400 TWO LOGAN SQUARE, 18TH AND ARCH STREETS, PHILADELPHIA, PA, 19103, US

(73) Assignee: UBE INDUSTRIES, LTD., a Japanese corporation, Ube-Shi (JP)

(21) Appl. No.: 10/628,817

(22) Filed: Jul. 28, 2003

(30) Foreign Application Priority Data
Jul. 31, 2002 (JP) 2002-222671(PAT.

(51) Int. Cl. B32B 27/14

(52) U.S. Cl. 428/325; 428/473.5; 428/702

(57) ABSTRACT

An antistatic film with a surface resistivity of 10¹³ Ω/□, comprising a metal oxide and conductive ultrafine particle mixed layer formed on the surface of a film, and a process for manufacture of the antistatic film which comprises coating the surface of a self-supporting film, obtained by casting and drying a solution of a heat-resistant resin precursor, with a mixture obtained by uniformly combining a metal compound which converts to a metal oxide upon heating, conductive ultrafine particles and a solvent, and then heating it to dryness, removing the solvent and cyclizing the heat-resistant resin precursor. The film exhibits improved antistatic retention with no reduction in its original mechanical properties and formed without the use of special equipment such as a sputtering apparatus, as well as a process for its manufacture.

### BACKGROUND OF THE INVENTION

1. Field of the Invention

The present invention relates to an antistatic film with improved conductive fine particle surface retention and to a process for its manufacture, and more specifically it relates to an antistatic film which is suitable as a Multiple Layer Insulation (MLI) film or thermal blanket for space applications, and to a process for its manufacture.

The “metal oxide” referred to throughout the present specification is one having a resistivity of at least 10⁶ Ω·cm or greater at room temperature.

2. Description of Related Art

Numerous types of heat-resistant films are used as thermal control materials for artificial satellites, space shuttles, space stations and the like. Typically these are polyimide films, fluorine resin films or the like.

Such heat-resistant films become unable to exhibit their original effects as thermal control materials when colliding dirt or dust in space attaches to them.

Consequently, various approaches have been adopted in an attempt to overcome this problem. For example, metal or metal oxide layers have been formed on the surfaces of polyimide films as antistatic measures to prevent adhesion of dirt or dust.

On the other hand, Japanese Unexamined Patent Publication No. 2001-115251, for example, describes an antistatic protective film obtained by forming a conductive layer on the surface of a film by sputtering of a metal such as stainless steel.

However, because films obtained in this manner require apparatuses with high vacuum degrees or highly-precise atmospheric control for sputtering, they are costly and reduce productivity.

In addition, Japanese Unexamined Patent Publication No. 10-77406 describes an antistatic polyimide film having antimony-containing tin oxide-coated conductive silica particles dispersed in an aromatic polyimide, while Japanese Unexamined Patent Publication No. 7-156287 describes a semiconducting polyimide-based endless belt laminated with a conductive film having a conductive substance such as carbon black dispersed in a resin.

However, the film and belt described in these publications require addition of large amounts of conductive material to confer the antistatic property, and this reduces the mechanical properties of the polyimide film or belt.

### BRIEF SUMMARY OF THE INVENTION

It is an object of the present invention to provide an antistatic film exhibiting improved antistatic retention without using special equipment such as sputtering apparatuses and without reducing the original mechanical properties of the film, as well as a process for manufacture of the film.

The present invention relates to an antistatic film with a surface resistivity of no greater than 10¹³ Ω/□, comprising a metal oxide and conductive ultrafine particle mixed layer formed on the surface of a film.

The invention further relates to a process for manufacture of the aforementioned antistatic film which comprises coating the surface of a self-supporting film, obtained by casting and drying a solution of a film-forming heat-resistant resin precursor, with a mixture obtained by uniformly combining a metal compound which converts to a metal oxide upon heating, conductive ultrafine particles and a solvent, and then heating it to dryness, removing the solvent and cyclizing the heat-resistant resin precursor.

The invention still further relates to a process for manufacture of an antistatic film which comprises coating the surface of a self-supporting film, obtained from a polyimide precursor solution, with a mixture comprising a metal compound which converts to a metal oxide upon heating, conductive ultrafine particles and a solvent, and then drying it to obtain a dry film with a metal compound and conductive ultrafine particle mixed layer, and heating the dry film at a temperature of 420° C. or above to complete imide cyclization, thereby forming on the film surface a metal oxide and conductive ultrafine particle mixed layer having a surface resistance value of no greater than 10¹³ Ω/□.

### BRIEF DESCRIPTION OF THE DRAWINGS

FIG. 1 is a graph showing the light transmittance of the antistatic film obtained in Example 3 as an embodiment of the invention.

### DETAILED DESCRIPTION OF THE INVENTION

Preferred embodiments of the invention will now be described.

1) The aforementioned antistatic film, wherein the metal oxide and conductive ultrafine particle mixed layer comprises the metal of the metal oxide and the conductive ultrafine particles in a weight ratio (metal/conductive ultrafine particles) of 0.01-0.1, and particularly 0.03-0.1.

2) The aforementioned antistatic film, wherein the film is a polyimide film.

3) The aforementioned antistatic film, wherein the metal oxide is an aluminum oxide.

4) The aforementioned antistatic film, wherein the mixed layer is formed by a coating method.

5) The aforementioned antistatic film, wherein the polyimide film is obtained from a tetracarboxylic acid component and a diamine component in a solvent.

6) The aforementioned antistatic film, wherein the tetracarboxylic acid component is 3,3′,4,4′-biphenyltetracarboxylic dianhydride.

7) The aforementioned antistatic film, wherein the conductive ultrafine particles have a mean particle size of no greater than 0.1 μm.

8) The aforementioned antistatic film, wherein the conductive ultrafine particles are ITO ultrafine particles.

9) The aforementioned process for manufacture of an antistatic film, wherein the metal compound is an organic aluminum compound.

As films to be used for the invention there may be mentioned heat-resistant resin films such as polyimide films, aromatic polyamide films and the like, and preferably polyimide films.

There are no particular restrictions on the polyimide films, and suitable examples include those comprising pyromellitic dianhydride (KAPTONE H, KAPTONE E, KAPTONE EN, KAPTONE V, etc. by Toray/DuPont; APICAL series by Kaneka Corp.) as an essential component, and those comprising 3,3′,4,4′-biphenyltetracarboxylic dianhydride (UPILEX-R, UPILEX-S by Ube Industries, Ltd.) as an essential component. These polyimide films preferably have thicknesses of about 7.5-125 μm.

As metal oxides there may be mentioned aluminum oxides (for example, Al₂O₃), silica oxides (for example, SiO₂), zirconium oxides (for example, ZrO₂), magnesium oxides (for example Mgo) and calcium oxides (for example, CaO).

As conductive ultrafine particles there may be mentioned ITO ultrafine particles, and electroless plated ultrafine particles obtained by coating the surface of an inorganic substance core material (for example, glass, ceramic or metal carbide) with a metal (for example, Fe, Cu, Co, Ge, Ag, Pd, Au, etc.) by electroless plating. The conductive ultrafine particles preferably have a mean particle size of no greater than 0.1 μm.

The metal oxide and conductive ultrafine particle mixed layer is preferably formed by a coating method, whereby it is possible to obtain an antistatic film with virtually no reduction in surface resistivity even after release treatment.

The coating method may be, for example, a method of coating the surface of a self-supporting film with a mixture obtained by uniformly combining the metal compound, conductive ultrafine particles and a solvent, and then heating it to dryness.

The metal oxide and conductive ultrafine particle mixed layer preferably comprises the metal of the metal oxide and the conductive ultrafine particles in a weight ratio (metal/conductive ultrafine particles) of 0.01-0.1, and especially 0.03-0.1.

The metal oxide and conductive ultrafine particle mixed layer preferably has a thickness of 0.05 μm or greater, and may be formed on either side or on both sides of the film.

The antistatic film of the invention may be obtained by coating the surface of a self-supporting film with a thickness of preferably about 10-250 μm which is obtained, for example, by casting and drying a solution of a film-forming heat-resistant resin precursor, with a mixture obtained by uniformly combining a metal compound, conductive ultrafine particles and a solvent, and then heating it to dryness, removing the solvent and completing cyclization of the heat-resistant resin precursor.

As preferred heat-resistant resin precursors there may be mentioned polyimide precursors obtained from 3,3′,4,4′-biphenyltetracarboxylic dianhydride (hereinafter abbreviated as S-BPDA) and paraphenylenediamine (hereinafter also abbreviated as PPD), or in some cases also with 4,4′-diaminodiphenyl ether and/or pyromellitic anhydride (hereinafter also abbreviated as PMDA). In such cases, the PPD/DADE (molar) ratio is preferably from 100/0 to 85/15. The s-BPDA/PMDA ratio is preferably from 100/0 to 50/50.

As additional heat-resistant resin precursors there may be mentioned polyimide precursors obtained from pyromellitic anhydride, paraphenylenediamine and 4,4′-diaminodiphenyl ether. In such cases the DADE/PPD (molar) ratio is preferably from 90/10 to 10/90.

So long as the final proportions of the components are within the aforementioned ranges, the polyimide precursor may be synthesized by any desired method such as random polymerization, block polymerization, blending or copolymerization involving pre-synthesis of two or more polyimide precursor (polyamic acid) solutions and mixing of the polyamic acid solutions for rebonding of the polyamic acids.

As organic solvents used to obtain the polyamic acid(s) there may be mentioned N-methyl-2-pyrrolidone, N,N-dimethylformamide, N,N-dimethylacetamide, N,N-diethylacetamide, dimethylsulfoxide, hexamethylphosphoramide, N-methylcaprolactam, cresols and the like. Such organic solvents may be used alone or in combinations of two or more.

A basic organic compound-based catalyst may also be added to the dope solution to accelerate imidation. For example, imidazole, 2-imidazole, 1,2-dimethylimidazole, 2-phenylimidazole or the like may be used in a proportion of 0.01-20 wt % and especially 0.5-10 wt % with respect to the polyamic acid (solid portion). These catalysts are used to avoid insufficient imidation as a consequence of forming the polyimide film at relatively low temperature.

The surface of the self-supporting film on which the extruded layer of the polyimide-forming polyimide precursor solution has been dried is then coated with the mixture obtained by uniformly combining a metal compound, conductive ultrafine particles and a solvent.

As metal compounds there may be mentioned aluminum compounds, silicon compounds such as tetraethoxysilane and dimethoxydimethylsilane, zirconium compounds such as zirconium tetraisopropoxide and zirconium tetra-n-butoxide and the like, and especially aluminum compounds.

As examples of aluminum compounds there may be mentioned aluminum hydroxide, and organic aluminum compounds such as aluminum ethyl acetoacetate diisopropylate, aluminum monoethylacetate diisopropylate, aluminum diethylacetate monoisopropylate, aluminum triacetylacetate, aluminum triethyl acetoacetate, aluminum isopropylate, aluminum butylate, aluminum oxide octylate trimer, aluminum oxide stearate trimer, aluminum oxide isopropoxide trimer and aluminum oxide laurate trimer.

For coating of the self-supporting film with the solvent mixture comprising the metal oxide and conductive ultrafine particles in the method described above, the concentration of each of the coated metal compound and the conductive ultrafine particles is preferably about 0.01-20 wt % and especially 0.01-10 wt %. There are no particular restrictions on the solvent to be used for the coating mixture, and there may be mentioned alcohols, aromatic hydrocarbons, aliphatic hydrocarbons, alicyclic hydrocarbons, ketone solvents, ether solvents, amide solvents. As specific examples of polymerization solvents there may be mentioned N-methyl-2-pyrrolidone, N,N-dimethylformamide, N,N-dimethylacetamide, N,N-diethylacetamide, dimethylsulfoxide, hexamethylphosphoramide, N-methylcaprolactam, cresols and the like, or alcohols such as n-butanol, isopropanol and the like.

The self-supporting film may be obtained, for example, by reacting the tetracarboxylic acid component and diamine component in an organic solvent at a temperature of no higher than about 100° C., and especially 20-60° C., to prepare a polyimide precursor (polyamic acid) solution, and then using the polyamic acid solution as a dope solution for casting onto a support, drying it at about 70-200° C. to form a thin-film, and releasing it from the support. In order to facilitate release of the thin-film, an organic phosphorus compound, for example, triphenyl phosphite, triphenyl phosphate or an alkylphosphoric acid ester salt, may be added during the polyamic acid polymerization in the range of 0.05-1% with respect to the concentration of the solid portion (polymer).

According to the invention, an antistatic film may be obtained by coating the surface of a self-supporting film with a mixture obtained by uniformly combining a metal compound, conductive ultrafine particles and a solvent, and then heat drying it, preferably at a maximum temperature of 420° C. or above for about 1-60 minutes, and removing the solvent and cyclizing (imide cyclizing) the heat-resistant resin precursor.

Because the antistatic film of the invention contains no conductive ultrafine particles in the film, the original mechanical properties of the film itself are maintained, the surface resistivity is no greater than 10¹³ ∩/□, preferably no greater than 10⁸ Ω/□ and especially 10⁴-10⁸ Ω/□ and the conductive ultrafine particles are firmly held in the film by the metal oxide, thereby allowing the surface resistance value to be kept within less than 10-fold compared to the initial value, even if a release effect is conferred.

The present invention will now be explained in greater detail through the following examples.

The following abbreviations are used to signify the following compounds.

s-BPDA: 3,3′,4,4′-Biphenyltetracarboxylic dianhydride

s-PBTA: 3,3′,4,4′-Biphenyltetracarboxylic acid

PPD: p-Phenylenediamine

DMAc: N,N-Dimethylacetamide

ALCH: Aluminum ethyl acetoacetate diisopropylate

The film properties in the examples were determined by the following methods.

1) Surface Resistivity (Also Known as Surface Resistance Value)

This was measured according to ASTM D257, using a surface resistance meter (High Resistance Meter, Agilent Technologies 4339, product of Agilent Technologies) at 23° C., 45% RH.

2) Evaluation of Retention of Antistatic Property of Film Surface

Adhesive tape (Scotch 610-1PK, product of 3M Co.) was attached to the conductive ultrafine particle layer of the film, and then the adhesive tape was released at a pull rate of 60 m/min, the surface resistivity was measured, and the change in surface resistivity was determined. The surface property retention was evaluated based on the change in surface resistivity.

The surface property retention was evaluated in the following manner. ◯ (good)=surface resistivity after release changed only by less than 10-fold with respect to the surface resistivity before release; X (poor)=changed by 10-fold or more.

3) Measurement of Light Transmittance

The measurement was conducted according to JIS Z8722 using a spectrophotometer (V-570) by Jasco Co.

4) Mechanical Properties (Elongation, Tensile Strength, Elastic Modulus): Measured According to ASTM D882.

### REFERENCE EXAMPLE 1

After adding 183 g of DMAc and 0.1 g of a phosphorus compound (SEPERL 365-100, product of Chukyo Yushi Co., Ltd.) to a 300 ml-volume four-necked separable flask equipped with a stirrer, reflux condenser (with water separator), thermometer and nitrogen inlet tube, 10.81 g (0.1 mol) of PPD was added while stirring under a nitrogen stream and the mixture was heated at 50° C. to complete dissolution. Next, 29.229 g (0.09935 mol) of s-BPDA was slowly added to the solution with attention to heat release, and upon completion of the addition, the reaction was continued for 5 hours while maintaining a temperature of 50° C. A 0.2381 g (0.00065 mol) portion of s-BPTA was then dissolved therein. The resulting aromatic polyamic acid solution was a viscous brown liquid which exhibited a solution viscosity of 1500 poise at 25° C. (measured with a VISCONIC EHD E type viscometer by Tokyo Keiki Co., Ltd.).

### EXAMPLES 1-3

The polyamic acid solution obtained in Reference Example 1 was cast and coated onto a glass plate and dried at 135° C. for 3 minutes, after which it was coated with a mixture obtained by adding DMAc and ALCH (Kawaken Fine Chemicals Co., Ltd.) to an ITO ultrafine particle dispersion (ITO ultrafine particle mean size: 20-30 nm, 10 wt % ITOANB-G180, product of C.I. Kasei Co., Ltd.) and dried at 135° C. for 1 minute. The resulting film was then peeled from the glass plate and bound on a frame, and then heat treated at 150° C. for 3 minutes, at 180° C. for 3 minutes, at 300° C. for 3 minutes and at 480° C. for 3 minutes-to obtain an antistatic aromatic polyimide film comprising a 0.15 μm thick ITO film on one side of a 25 μm thick polyimide film. The ITO ultrafine particle layer of the obtained antistatic aromatic polyimide film was transparent in all of Examples 1 to 3.

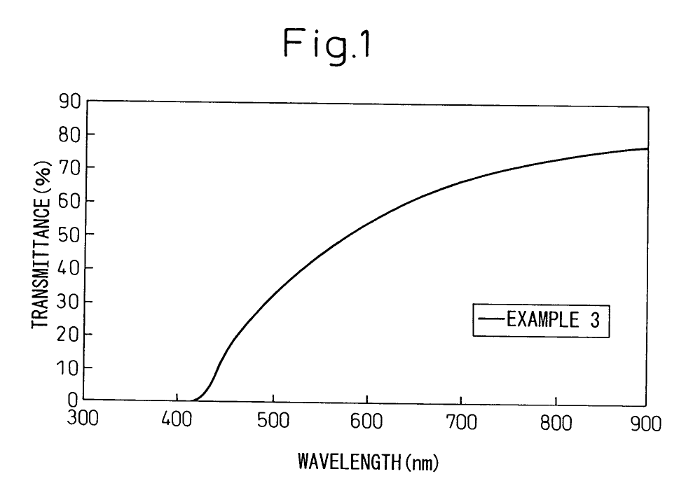

The metal compound and ITO ultrafine particle dispersion mixture compositions and film evaluation results are summarized in Tables 1 and 2. The light transmittance for one of the antistatic aromatic polyimide films is shown in FIG. 1.

### COMPARATIVE EXAMPLE 1

A film was obtained in the same manner as Example 1, except that no ALCH was used. The ITO ultrafine particle layer of the obtained antistatic polyimide film was transparent.

The ultrafine particle dispersion mixture composition and film evaluation results are summarized in Tables 1 and 2. The polyimide films obtained in Examples 1 to 3 were confirmed to have mechanical properties and light transmittance equivalent to the polyimide film obtained in Comparative Example 1.

TABLE 1

| | Conduc- | Conduc- | | Al/conduc- | |
|---|---|---|---|---|---|
| | tive | tive | | tive | |
| | ultrafine | ultrafine | | ultrafine | |
| | particle | particle | | particle | |
| | solution | content | ALCH | weight | DMAc |
| | (g) | (g) | (g) | ratio | (g) |
| Example 1 | 1.00 | 0.10 | 0.05 | 4.9 | 1.00 |
| Example 2 | 1.00 | 0.10 | 0.05 | 4.9 | 2.00 |
| Example 3 | 1.00 | 0.10 | 0.07 | 6.9 | 1.00 |
| Comp. Ex. 1 | 1.00 | 0.10 | 0 | 0 | 0.96 |

TABLE 2

| | | Surface | |
|---|---|---|---|
| | Surface | resistance | Evaluation |
| | resistance | value after | of surface |
| | value | release test | retention |
| Example 1 | 6.3 × 10⁴ | 1.0 × 10⁵ | ◯ |
| Example 2 | 3.2 × 10⁶ | 5.0 × 10⁶ | ◯ |
| Example 3 | 6.3 × 10⁴ | 1.6 × 10⁵ | ◯ |
| Comp. Ex. 1 | 6.3 × 10⁴ | 1.0 × 10⁹ | X |

According to the present invention, the following effects are exhibited as a result of the construction described above.

An antistatic film of the invention maintains a surface resistance value of no greater than 10¹³ Ω/□ while also maintaining the original mechanical properties of the film.

According to the process of the invention it is possible to obtain an antistatic film which easily maintains its original mechanical properties without the use of special equipment, and maintain a surface resistance value of no greater than 10¹³ Ω/□.

What is claimed is:

1. An antistatic film with a surface resistivity of no greater than 10¹³ Ω/□, comprising a metal oxide and conductive ultrafine particle mixed layer formed on the surface of a film.

2. An antistatic film according to claim 1, wherein the metal oxide and conductive ultrafine particle mixed layer comprises the metal of the metal oxide and the conductive ultrafine particles in a weight ratio (metal/conductive ultrafine particles) of 0.01-0.1.

3. An antistatic film according to claim 1, wherein the film is a polyimide film.

4. An antistatic film according to claim 3, wherein the polyimide film is obtained from a tetracarboxylic acid component and a diamine component.

5. An antistatic film according to claim 4, wherein the tetracarboxylic acid component is 3,3′,4,4′-biphenyltetracarboxylic dianhydride.

6. An antistatic film according to claim 1, wherein the metal oxide is an aluminum oxide.

7. An antistatic film according to claim 1, wherein the conductive ultrafine particles have a mean particle size of no greater than 0.1 μm.

8. An antistatic film according to claim 1, wherein the conductive ultrafine particles are ITO ultrafine particles.

9. An antistatic film according to claim 1, wherein the mixed layer is formed by a coating method.

10. A process for manufacture of an antistatic film according to claim 1, which comprises coating the surface of a self-supporting film, obtained by casting and drying a solution of a film-forming heat-resistant resin precursor, with a mixture obtained by uniformly combining a metal compound which converts to a metal oxide upon heating, conductive ultrafine particles and a solvent, and then heating it to dryness, removing the solvent and cyclizing the heat-resistant resin precursor.

11. A process for manufacture of an antistatic film according to claim 10, wherein the metal compound which converts to a metal oxide upon heating is an organic aluminum compound.

12. A process for manufacture of an antistatic film, which comprises coating the surface of a self-supporting film, obtained from a polyimide precursor solution, with a mixture comprising a metal compound which converts to a metal oxide upon heating, conductive ultrafine particles and a solvent, and then drying it to obtain a dry film with a metal compound and conductive ultrafine particle mixed layer, and heating the dry film at a temperature of 420° C. or above to complete imide cyclization, thereby forming on the film surface a metal oxide and conductive ultrafine particle mixed layer having a surface resistance value of no greater than 10¹³ Ω/□.
